(19) United States
(12) Patent Application Publication
(10) Pub. No.: US 2019/0118714 A1
(43) Pub. Date: Apr. 25, 2019

(54) ROTATION-SLIDING PORTION STRUCTURE

(71) Applicant: KABUSHIKI KAISHA TOKAI-RIKA-DENKI-SEISAKUSHO, Aichi (JP)

(72) Inventors: Suguru FUJISAKI, Aichi (JP); Shigeki YOSHIDA, Aichi (JP)

(21) Appl. No.: 16/092,537

(22) PCT Filed: Mar. 23, 2017
(86) PCT No.: PCT/JP2017/011815

§ 371 Date: Oct. 10, 2018

(30) Foreign Application Priority Data
Apr. 15, 2016 (JP) 2016-082266

(51) Int. Cl. B60R 1/06; F16C 33/10; F16C 17/04

(52) U.S. Cl. CPC B60R 1/06; F16C 17/04; F16C 33/102

(57) ABSTRACT

Grease is present between a support face of a case and a supported face of a gear plate that are capable of rotating relative to each other. A ring-shaped first groove is formed in the support face so as to run in a circumferential direction around a rotation center of the support face. Second grooves that link a radial direction inside end of the support face and the first groove together, and third grooves that link a radial direction outside end of the support face and the first groove together, are also formed in the support face. The second grooves and the third grooves extend at an angle toward the same side as each other with respect to a radial direction of the support face (a radial direction centered on a swing axial center of the case).

### TECHNICAL FIELD

The present invention relates to a rotation-sliding portion structure.

### BACKGROUND ART

Japanese Utility Model Application Laid-Open (JP-U) No. H07-4171 discloses an electric mirror structure. In this electric mirror, a washer clutch swings about a base shaft together with a drive case, and a restriction groove is coated with grease such that a protrusion provided at a lower face of the washer clutch moves smoothly inside the restriction groove.

### SUMMARY OF INVENTION

### Technical Problem

However, in the above technology, there is a possibility that wear of sliding portions might be exacerbated by depletion of the grease or the generation of powdered abrasion debris, leaving room for improvement regarding this point.

In consideration of the above circumstances, an object of the present invention is to obtain a rotation-sliding portion structure capable of suppressing wear of rotation-sliding portions.

### Solution to Problem

A rotation-sliding portion structure of a first aspect of the present disclosure includes a pair of ring-shaped sliding faces, a ring-shaped or circular arc shaped first groove, a second groove, and a third groove. The pair of ring-shaped sliding faces are capable of rotating relative to each other, and a lubricant is present between the pair of ring-shaped sliding faces. The ring-shaped or circular arc shaped first groove is formed in at least one sliding face of the pair of ring-shaped sliding faces so as to run in a circumferential direction around a rotation center of the at-least-one sliding face. The second groove is formed in the at-least-one sliding face so as to link a radial direction inside end of the at-least-one sliding face and the first groove together, and extends at an angle with respect to a radial direction of the at-least-one sliding face. The third groove is formed in the at-least-one sliding face so as to link a radial direction outside end of the at-least-one sliding face and the first groove together, and extends at an angle toward the same side as the second groove with respect to the radial direction of the at-least-one sliding face.

According to the rotation-sliding portion structure of the first aspect of the present disclosure, the lubricant is present between the pair of ring-shaped sliding faces that are capable of rotating relative to each other. The first groove formed in at least one sliding face of the sliding faces is formed in a ring shape or circular arc shape running in the circumferential direction around the rotation center of the at-least-one sliding face. Thus, when the pair of sliding faces rotate relative to each other, wear of the sliding faces is suppressed by the lubricant flowing out from the first groove toward the side of the sliding faces.

The second groove that links the radial direction inside end of the at-least-one sliding face and the first groove together, and the third groove that links the radial direction outside end of the at-least-one sliding face and the first groove together, are formed in the at-least-one sliding face. Note that the second groove and the third groove extend at an angle toward the same side as each other with respect to the radial direction of the sliding face in which they are formed. Thus, when the pair of sliding faces rotate relative to each other, some of the lubricant that has spilled out from between the pair of sliding faces flows through one of the second groove or the third groove to be supplied to the first groove, and powdered abrasion debris is discharged through the other of the second groove or the third groove. This enables depletion of the lubricant to be slowed, and enables abrasion of the sliding faces caused by powdered abrasion debris to be suppressed.

A rotation-sliding portion structure of a second aspect of the present disclosure is the configuration of the first aspect, wherein a connecting portion of the second groove to the first groove and a connecting portion of the third groove to the first groove are set at positions staggered with respect to each other in an extension direction of the first groove.

According to the rotation-sliding portion structure of the second aspect of the present disclosure, when the pair of sliding faces rotate relative to each other and some of the lubricant that has spilled out from between the pair of sliding faces flows into one of the second groove or the third groove, this flowing lubricant can be suppressed from passing straight across the first groove and being discharged from the other of the second groove or the third groove. This enables the lubricant supplied into the first groove to be efficiently utilized to suppress abrasion of the sliding faces.

A rotation-sliding portion structure of a third aspect of the present disclosure is the configuration of the first aspect or the second aspect, wherein a depth of the first groove is set deeper than respective depths of the second groove and the third groove.

According to the rotation-sliding portion structure of the third aspect of the present disclosure, lubricant is able to accumulate in the first groove at a position deeper than the second groove and the third groove. This enables the lubricant inside the first groove to be suppressed from being discharged through the second groove or the third groove. Since powdered abrasion debris generally floats on top of the lubricant, the powdered abrasion debris is discharged through the second groove or the third groove, despite the second groove and the third groove being shallower than the first groove.

### Advantageous Effects of Invention

As described above, the rotation-sliding portion structure according to the present invention exhibits the excellent advantageous effect of enabling wear of the rotation-sliding portions to be suppressed.

### BRIEF DESCRIPTION OF DRAWINGS

FIG. 1 is a face-on view illustrating a vehicle door mirror device according to an exemplary embodiment of the present invention, in a state viewed from a vehicle rear side.

FIG. 2 is an exploded perspective view illustrating a stowing mechanism of the vehicle door mirror device in FIG. 1.

FIG. 3 is a cross-section of the stowing mechanism of the vehicle door mirror device in FIG. 1, in a state viewed from the vehicle rear side.

FIG. 4 is a plan view illustrating a support face of a case, in a state viewed from the upper side.

FIG. 5A is a vertical cross-section illustrating a support face, a supported face, and so on at a position sectioned along line 5A-5A in FIG. 4.

FIG. 5B is a vertical cross-section illustrating a support face, a supported face, and so on at a position sectioned along line 5B-5B in FIG. 4.

FIG. 6 is a plan view illustrating a support face of a case of a modified example, in a state viewed from the upper side.

### DESCRIPTION OF EMBODIMENTS

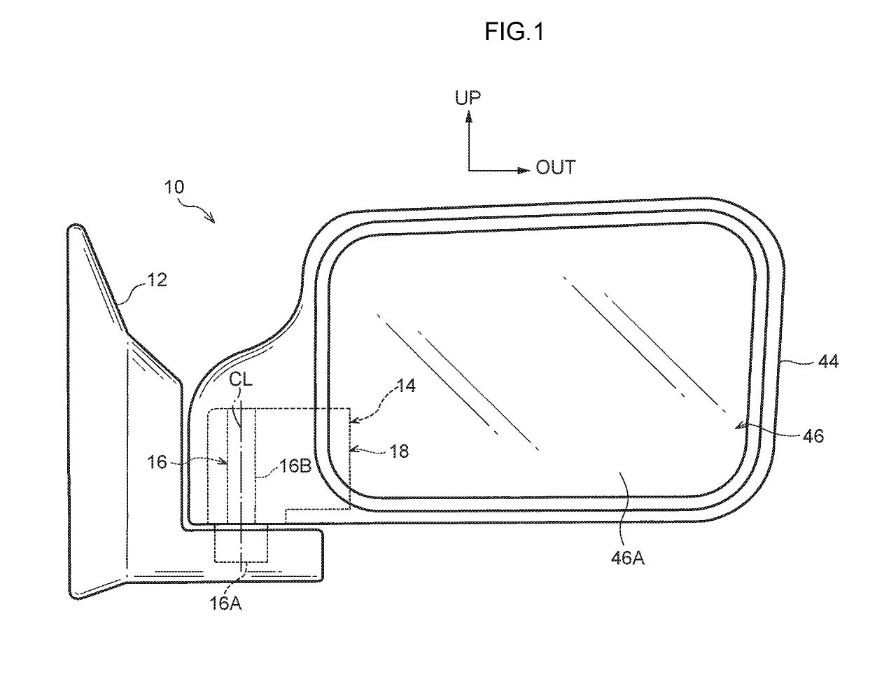

Explanation follows regarding a vehicle door mirror device (vehicle visual recognition device) according to an exemplary embodiment, applied with a rotation-sliding portion structure of the present invention, with reference to FIG. 1 to FIG. 5B. Note that in these drawings, the arrow FR indicates a vehicle front side, the arrow UP indicates a vehicle upper side, and the arrow OUT indicates a vehicle width direction outside, as appropriate.

FIG. 1 is a face-on view illustrating a vehicle door mirror device 10 according to the present exemplary embodiment, in a state viewed from the vehicle rear side. The vehicle door mirror device 10 according to the present exemplary embodiment is provided to an up-down direction intermediate portion at a vehicle front side end of a side door (specifically, a front side door), serving as a vehicle door, and is disposed at the vehicle exterior.

As illustrated in FIG. 1, the vehicle door mirror device 10 includes a stay 12 (installation member). The vehicle door mirror device 10 is installed to the side door (vehicle body side) by fixing a vehicle width direction inside end of the stay 12 to the side door. A stowing mechanism 14 (also referred to as a swing mechanism, an electrical stowing mechanism, an electrical stowing unit, or a retractor) is supported at the upper side of a vehicle width direction outside portion of the stay 12.

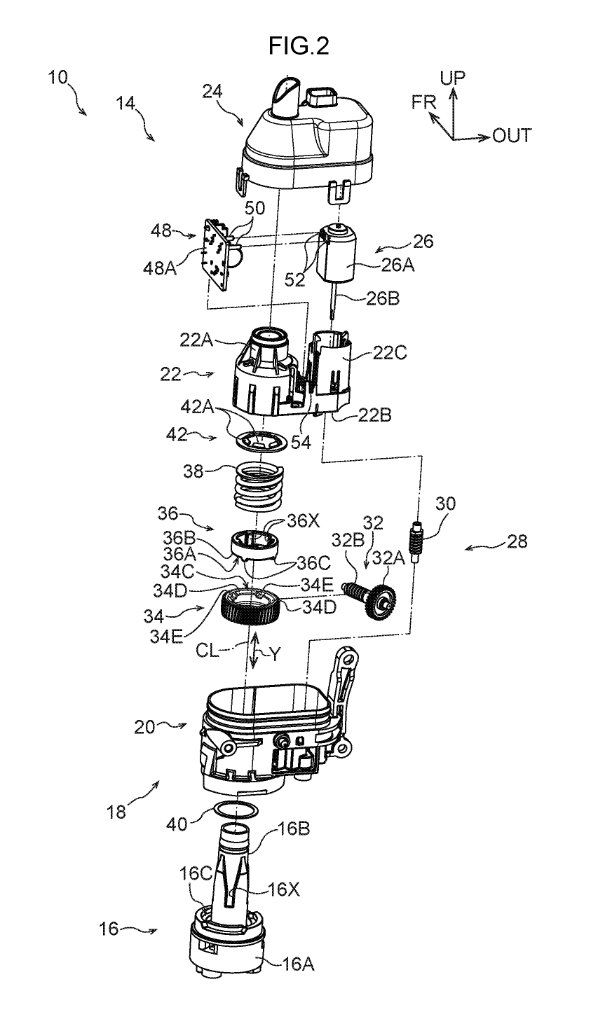

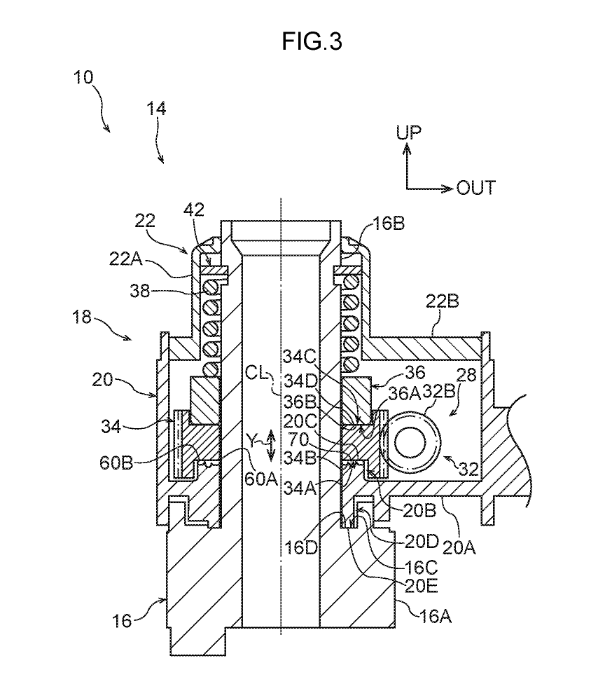

FIG. 2 is an exploded perspective view of the stowing mechanism 14, and FIG. 3 is a cross-section of the stowing mechanism 14 in a state viewed from the vehicle rear side.

A stand 16, serving as a support body on the side door (vehicle body side), is provided to the stowing mechanism 14 as illustrated in FIG. 2 and FIG. 3. A fixing portion 16A is provided at a lower portion of the stand 16. As illustrated in FIG. 1, the fixing portion 16A is fixed to the stay 12, thereby fixing the stand 16 to the stay 12 such that the stowing mechanism 14 is supported by the stay 12. A substantially circular cylinder shaped support shaft 16B is integrally provided projecting upward from the upper side of the fixing portion 16A. The axial direction of the support shaft 16B is disposed so as to run along the up-down direction.

As illustrated in FIG. 2, grooves 16X extending along the axial direction of the support shaft 16B are formed in an up-down direction intermediate portion of an outer circumferential portion of the support shaft 16B. Plural of the grooves 16X are formed in the outer circumferential portion of the support shaft 16B at uniform spacings around the circumferential direction. The grooves 16X each form a recess toward the radial direction inside of the support shaft 16B and are open toward the upper side.

As illustrated in FIG. 2 and FIG. 3, a ring-shaped recess 16C is provided to a lower portion of the stand 16 so as to encircle a lower end portion of the support shaft 16B. As illustrated in FIG. 2, a slip washer 40 is provided in the ring-shaped recess 16C. Note that the slip washer 40 is omitted from illustration in FIG. 3, which illustrates the ring-shaped recess 16C as a portion configured incorporating the slip washer 40. Grease (lubricant), not illustrated in the drawings, is applied to a support face portion 16D configuring a bottom face of the ring-shaped recess 16C.

A swing body 18 is capable of swinging about the support shaft 16B. The swing body 18 is supported from the lower side by the stand 16.

As illustrated in FIG. 2 and FIG. 3, a container-shaped resin case 20 (swing member) is provided at a lower portion of the swing body 18. The upper side of the case 20 is open. As illustrated in FIG. 3, a circular tube portion 20B is formed at a vehicle width direction inside portion of a lower wall 20A of the case 20 configuring part of the swing body 18. The circular tube portion 20B projects toward the upper side so as to run along an outer circumferential face of the support shaft 16B of the stand 16. The support shaft 16B of the stand 16 passes through an axial center portion of the circular tube portion 20B of the case 20.

A cylindrical supported tube portion 20D is formed projecting toward the lower side from the lower side of the circular tube portion 20B of the case 20. A downward-facing supported face portion 20E is formed at a leading end (lower end) of the supported tube portion 20D. The supported face portion 20E of the case 20 is supported (contacted) from the lower side by the support face portion 16D of the ring-shaped recess 16C of the stand 16 in a state of face-on-face contact. The supported face portion 20E of the case 20 is supported by the support face portion 16D of the stand 16 so as to be capable of swinging about the support shaft 16B. Namely, the supported face portion 20E and the support face portion 16D configure sliding faces that slide relative to each other.

A resin motor base 22 (assembly member) is fixed inside an upper portion of the case 20. A substantially circular cylinder shaped housing tube 22A is provided to a vehicle width direction inside portion of the motor base 22. The support shaft 16B of the stand 16 is coaxially housed inside the housing tube 22A. A substantially rectangular plate shaped bottom wall 22B is provided to a vehicle width direction outside portion of the motor base 22. The bottom wall 22B is integrally formed to a lower end portion of the housing tube 22A. As illustrated in FIG. 2, a substantially elliptical tube-shaped assembly tube 22C is integrally provided to an upper face of the bottom wall 22B. The assembly tube 22C is formed projecting out from the bottom wall 22B toward the upper side.

A container-shaped resin cover 24 (covering member) is provided at the upper side of the case 20 and the motor base 22. The lower side of the cover 24 is open. A lower end of the cover 24 is fixed to an outer periphery of an upper end portion of the case 20. The cover 24 covers the case 20 and the motor base 22 from the upper side.

A motor 26 (drive section) capable of outputting drive force is provided inside the stowing mechanism 14. A substantially elliptical column shaped body 26A is provided to the motor 26. The body 26A of the motor 26 is assembled inside the assembly tube 22C of the motor base 22 from the upper side and fixed thereto. A metal output shaft 26B (motor shaft) extends coaxially from the body 26A of the motor 26. The output shaft 26B is disposed such that its axial direction runs along the up-down direction, and the output shaft 26B passes through the bottom wall 22B of the motor base 22 and extends to the lower side of the motor base 22. When the motor 26 is driven, the output shaft 26B rotates, thereby operating the stowing mechanism 14.

A circuit board 48 is connected to the body 26A of the motor 26. A board body 48A is provided to the circuit board 48. A pair of terminals 50 are provided to an upper portion of the circuit board 48. The pair of terminals 50 extend from the board body 48A toward the vehicle width direction outside.

A pair of insertion ports 52 are provided at an upper portion of a vehicle width direction inside face of the body 26A of the motor 26. The pair of terminals 50 of the circuit board 48 are respectively inserted into the pair of insertion ports 52, such that the motor 26 and the circuit board 48 are electrically connected together. A lower end of the circuit board 48 is inserted into and supported by a groove 54 formed in the motor base 22. The circuit board 48 is thereby assembled at the vehicle width direction inside of the motor 26.

The circuit board 48 is electrically connected to a controller (not illustrated in the drawings) of the vehicle through a set of harnesses or the like (not illustrated in the drawings). Power is supplied to the motor 26 and the motor 26 is driven under the control of the controller, thereby rotating the output shaft 26B of the motor 26.

As illustrated in FIG. 2 and FIG. 3, a gear mechanism 28 is provided inside the case 20.

As illustrated in FIG. 2, the gear mechanism 28 is provided with a resin worm gear 30, serving as a first stage gear, at the lower side of the motor 26. The worm gear 30 is disposed with its axial direction along the up-down direction, and a lower portion of the worm gear 30 is supported by the lower wall 20A of the case 20 (see FIG. 3) so as to be capable of rotating. The output shaft 26B of the motor 26 is coaxially inserted into the worm gear 30 from the upper side. When the output shaft 26B rotates, the worm gear 30 rotates as a unit with the output shaft 26B.

The gear mechanism 28 is also provided with a worm shaft 32, serving as an intermediate gear, at the vehicle width direction inside of the worm gear 30. The axial direction of the worm shaft 32 is disposed extending along a horizontal direction, and the worm shaft 32 is supported by the case 20 so as to be capable of rotating. A resin helical gear 32A is coaxially provided to one end side portion (a vehicle rear side portion) of the worm shaft 32, and a metal worm gear 32B is coaxially provided to another end side portion (a vehicle front side portion) of the worm shaft 32. The helical gear 32A is meshed with the worm gear 30. When the worm gear 30 rotates, the helical gear 32A and the worm gear 32B rotate as a unit therewith, and the worm shaft 32 rotates.

The gear mechanism 28 is also provided with a metal gear plate 34 (worm wheel) at the vehicle width direction inside of the worm shaft 32. The gear plate 34 is a member with an outer circumferential face that receives drive force from the motor 26 through the worm shaft 32 and so on, and is provided around the support shaft 16B. The support shaft 16B of the stand 16 passes coaxially through the gear plate 34, and the gear plate 34 is capable of rotating about the support shaft 16B. Note that in the drawings, the rotation axial center (rotation axis) of the gear plate 34, the swing axial center (swing axis) of the circular tube portion 20B of the case 20, and the axial center of the support shaft 16B of the stand 16 are indicated by the same single-dotted dashed line CL for convenience.

As illustrated in FIG. 3, a recess 34A that is recessed toward the upper side and encircles an outer circumferential face of the circular tube portion 20B of the case 20 is formed in the gear plate 34. A supported face 34B is formed at a downward-facing bottom face of the recess 34A. The supported face 34B is supported (contacted) from the lower side by a support face 20C, configuring an upper face of the circular tube portion 20B of the case 20, in a state of face-on-face contact. Namely, the support face 20C and the supported face 34B, these being mutually contacting portions of the case 20 and the gear plate 34, configure a pair of ring-shaped sliding faces that are capable of rotating relative to each other and that slide relative to each other, and are applied with the rotation-sliding portion structure of the present invention. Grease 70, serving as a lubricant, is present between the support face 20C and the supported face 34B. Grease that has spilled out (not illustrated in the drawings) from between the support face 20C and the supported face 34B is also present in the vicinity of a radial direction inside end 60A of the support face 20C and in the vicinity of a radial direction outside end 60B of the support face 20C.

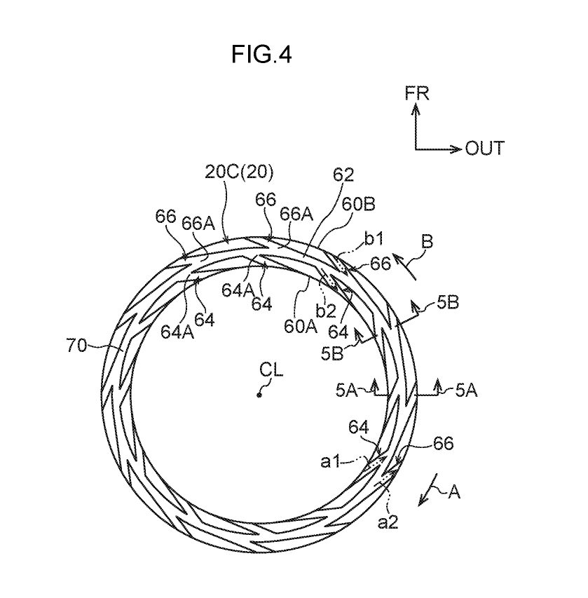

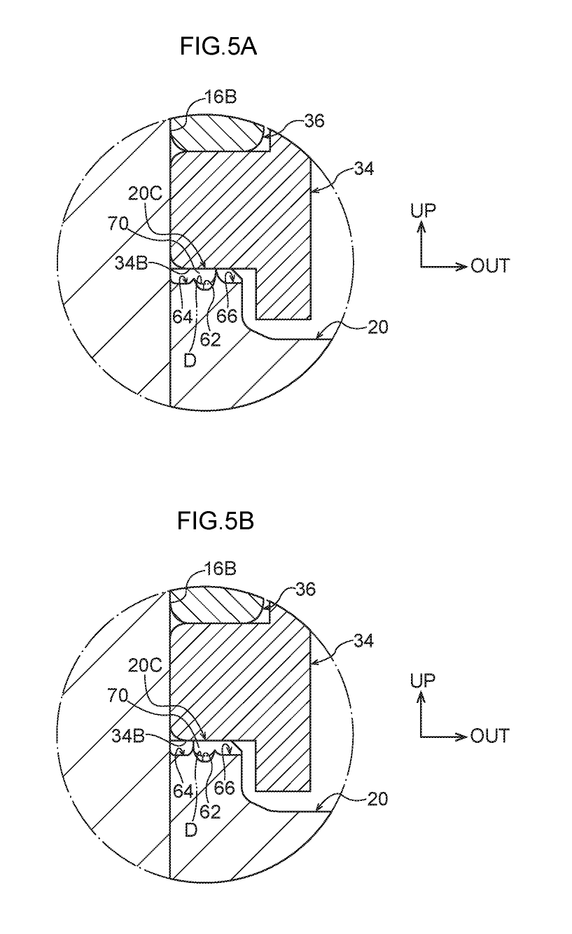

FIG. 4 is a plan view illustrating the support face 20C, serving as one sliding face (a lower side sliding face), as viewed from the upper side. FIG. 5A is a vertical cross-section illustrating the support face 20C, the supported face 34B (see FIG. 3), and so on at a position sectioned along line 5A-5A in FIG. 4. FIG. 5B is a vertical cross-section illustrating the support face 20C, the supported face 34B (see FIG. 3), and so on at a position sectioned along line 5B-5B in FIG. 4.

As illustrated in FIG. 4, a ring-shaped first groove 62 is formed in the support face 20C so as to run in the circumferential direction around a rotation center of the support face 20C (the swing axial center (CL) of the case 20). In the present exemplary embodiment, the first groove 62 is set at a central portion between the radial direction inside end 60A of the support face 20C and the radial direction outside end 60B of the support face 20C.

Plural second grooves 64 that link the radial direction inside end 60A of the support face 20C and the first groove 62 together are also formed in the support face 20C. The second grooves 64 extend at an angle with respect to the radial direction of the support face 20C (a radial direction centered on the swing axial center (CL) of the case 20), and are formed running in straight lines as an example. The plural second grooves 64 are disposed at uniform spacings in the circumferential direction around the support face 20C.

Plural third grooves 66 that link the radial direction outside end 60B of the support face 20C and the first groove 62 together are also formed in the support face 20C. The third grooves 66 extend at an angle toward the same side as the second grooves 64 with respect to the radial direction of the support face 20C (the radial direction centered on the swing axial center (CL) of the case 20). Namely, the second grooves 64 and the third grooves 66 are angled toward the same side as each other on progression toward the radial direction outside of the support face 20C. As an example, the third grooves 66 are formed running in straight lines, similarly to the second grooves 64. The plural third grooves 66 are also disposed at uniform spacings in the circumferential direction around the support face 20C.

Connecting portions 64A of the second grooves 64 to the first groove 62 and connecting portions 66A of the third grooves 66 to the first groove 62 are set at staggered positions in an extension direction of the first groove 62 (the circumferential direction of the first groove 62). In the present exemplary embodiment as illustrated in FIG. 5A and FIG. 5B, the depth of the second grooves 64 and the depth of the third grooves 66 are set so as to be the same as each other, and the depth of the first groove 62 is set deeper than the respective depths of the second grooves 64 and the third grooves 66.

As illustrated in FIG. 3, a ring-shaped upper face 34C of the gear plate 34 that is recessed slightly toward the lower side is formed with upper side contact faces 34D and detent recesses 34E (see FIG. 2). The upper side contact faces 34D make face-on-face contact with a clutch plate 36, described later, from the lower side. The detent recesses 34E serve as an engaged location. As illustrated in FIG. 2, the upper side contact faces 34D and the detent recesses 34E (four of each being formed in the present exemplary embodiment as an example) are formed alternately around the ring-shaped upper face 34C of the gear plate 34.

The plural detail recesses 34E are disposed at uniform spacings around the circumferential direction of the gear plate 34. A vertical cross-section profile of each detent recess 34E taken around the circumferential direction of the gear plate 34 forms an inverted trapezoidal shape set with a longer dimension at an upper end opening than at the base.

The clutch plate 36 (engagement member) is provided encircling the support shaft 16B at the upper side of the gear plate 34. The clutch plate 36 is made of metal and is formed in a substantially circular cylinder shape. The support shaft 16B of the stand 16 passes coaxially through the clutch plate 36. Protrusions 36X that extend along the axial direction of the clutch plate 36 and protrude toward the radial direction inside of the clutch plate 36 are formed to an inner circumferential side of the clutch plate 36. Plural of the protrusions 36X are formed to an inner circumferential portion of the clutch plate 36 at uniform spacings around the circumferential direction, and are fitted into the grooves 16X formed in the support shaft 16B of the stand 16. The clutch plate 36 is thereby rendered incapable of rotating about the support shaft 16B, and capable of moving along the axial direction of the support shaft 16B (up-down direction (arrow Y direction)). Note that in the drawings, the axial center (axis) of the clutch plate 36 is indicated by the same single-dotted dashed line CL as the axial center of the support shaft 16B and so on for convenience.

The clutch plate 36 includes a lower face 36A disposed in a state of face-on-face contact with the upper side contact faces 34D of the gear plate 34. Lower side contact faces 36B that are normally (when a visor 44 (see FIG. 1) or the like is not being applied with an external force with a high load) in face-on-face contact with the upper side contact faces 34D of the gear plate 34 are formed to the lower face 36A of the clutch plate 36. Detent protrusions 36C, serving as engagement locations, are also formed to the lower face 36A. The lower side contact faces 36B and the detent protrusions 36C (four of each in the present exemplary embodiment as an example) are formed alternately around the ring-shaped lower face 36A of the clutch plate 36.

The plural detent protrusions 36C are disposed at uniform spacings around the circumferential direction of the clutch plate 36. A vertical cross-section profile of each detent protrusion 36C taken around the circumferential direction of the clutch plate 36 forms an inverted trapezoidal shape set with a longer dimension along an upper end side than along a lower end side. The cross-section profiles of the detent protrusions 36C of the clutch plate 36 are similar in shape to, but slightly smaller than, the cross-section profiles of the detent recesses 34E of the gear plate 34.

Namely, the detent protrusions 36C of the clutch plate 36 are capable of being inserted into the detent recesses 34E of the gear plate 34, and the detent recesses 34E of the gear plate 34 and the detent protrusions 36C of the clutch plate 36 are capable of engaging with each other. When the detent protrusions 36C of the clutch plate 36 have been inserted into the detent recesses 34E of the gear plate 34, the lower side contact faces 36B of the clutch plate 36 make face-on-face contact with the upper side contact faces 34D of the gear plate 34.

A coil spring 38 (compression coil spring), this being an urging member, is provided encircling the support shaft 16B at the upper side of the clutch plate 36. The coil spring 38 is formed in a helical shape and is made of metal. The support shaft 16B of the stand 16 is coaxially inserted inside the coil spring 38.

A substantially annular plate shaped bush nut 42 (anchor member) is provided at the upper side of the coil spring 38. The bush nut 42 includes plural anchor claws 42A that are anchored to the support shaft 16B of the stand 16 such that the bush nut 42 is coaxially fixed to the support shaft 16B of the stand 16. In a state in which the bush nut 42 is fixed to the support shaft 16B, the bush nut 42 pushes and compresses the coil spring 38 toward the lower side, such that the coil spring 38 urges the clutch plate 36 toward the lower side so as to contact the gear plate 34. A state in which the clutch plate 36 is engaged with the gear plate 34 and the detent protrusions 36C of the clutch plate 36 are inserted into the detent recesses 34E of the gear plate 34 is thereby maintained by the urging force of the coil spring 38, such that the clutch plate 36 and the like restrict rotation of the gear plate 34 about the support shaft 16B.

The worm gear 32B of the worm shaft 32 is meshed with the gear plate 34. Thus, when the worm gear 32B rotates, the worm gear 32B swings about the gear plate 34, such that the swing body 18 swings with respect to the gear plate 34 as a unit with the worm gear 32B. Namely, the restriction on the gear plate 34 rotating about the support shaft 16B is maintained when the gear plate 34 receives drive three from the motor 26 while rotation is being restricted, such that drive force from the motor 26 is caused to act on the swing body 18 as a swinging force.

As illustrated in FIG. 1, the swing body 18 is housed inside a vehicle width direction inside portion of the substantially rectangular container-shaped visor 44 (housing member). The visor 44 is open toward the vehicle rear side. A mirror 46 (visual recognition section) is disposed inside the visor 44 in the vicinity of the opening. The mirror 46 is formed in a substantially rectangular plate shape, and the visor 44 covers the entire periphery and a vehicle front side face of the mirror 46.

The visor 44 and the mirror 46 are coupled to and supported by the swing body 18. The visor 44 and mirror 46 project out from the side door, and are unfolded (deployed) with respect to the side door together with the swing body 18. A mirror surface 46A of the minor 46 faces toward the vehicle rear side. The mirror 46 enables a vehicle occupant (the driver in particular) to view behind the vehicle, thereby assisting visual recognition of the occupant. Moreover, the visor 44 and the mirror 46 are capable of swinging about the support shaft 16B of the stand 16 as a unit with the swing body 18.

Explanation follows regarding operation and advantageous effects of the above exemplary embodiment.

As illustrated in FIG. 3, in the stowing mechanism 14 of the vehicle door mirror device 10 of the present exemplary embodiment, the urging force of the coil spring 38 causes the detent protrusions 36C of the clutch plate 36 (see FIG. 2) to engage with the detent recesses 34E of the gear plate 34 (see FIG. 2). Thus, the gear plate 34 is restricted from rotating with respect to the clutch plate 36. The swing body 18, the visor 44, and the mirror 46 illustrated in FIG. 1 are thereby restricted from rotating in a rearward folding direction and a forward folding direction.

When the stowing mechanism 14 illustrated in FIG. 3 is operated such that the motor 26 illustrated in FIG. 2 is driven under the control of the controller (not illustrated in the drawings), the output shaft 26B of the motor 26 rotates. In the gear mechanism 28, the worm gear 30 rotates as a unit with the output shaft 26B, thereby rotating the worm shaft 32 (the helical gear 32A and the worm gear 32B) such that the worm gear 32B swings about the gear plate 34. The swing body 18, the visor 44, and the mirror 46 illustrated in FIG. 1 thereby swing about the gear plate 34 as a unit with the worm gear 32B illustrated in FIG. 2.

When the motor 26 is driven under the control of the controller (not illustrated in the drawings) such that the output shaft 26B of the motor 26 rotates in one direction, the worm gear 32B swings in the rearward folding direction about the gear plate 34, such that the swing body 18, the visor 44, and the mirror 46 illustrated in FIG. 1 swing in the rearward folding direction (toward the vehicle rear side and vehicle width direction inside). The swing body 18, the visor 44, and the mirror 46 are thereby stowed (stowed toward the rear), such that they no longer project out from the side door.

When the motor 26 illustrated in FIG. 2 is then driven under the control of the controller (not illustrated in the drawings) such that the output shaft 26B of the motor 26 rotates in the other direction, the worm gear 32B swings in the forward folding direction about the gear plate 34, such that the swing body 18, the visor 44, and the mirror 46 illustrated in FIG. 1 also swing in the forward folding direction (toward the vehicle front side and vehicle width direction outside). Thus, the swing body 18, the visor 44, and the mirror 46 are unfolded (returned) so as to project out from the side door.

If an external force with a large load acts on at least one of the visor 44 or the mirror 46 in one of the rearward folding direction or the forward folding direction, rotation force with a large load in the one of the rearward folding direction or the forward folding direction is input to the gear plate 34 from the worm gear 32B of the swing body 18 illustrated in FIG. 3. When this occurs, the engagement between the detent protrusions 36C of the clutch plate 36 and the detent recesses 34E of the gear plate 34 as illustrated in FIG. 2 is released by the clutch plate 36 moving toward the upper side against the urging force of the coil spring 38. Since the upper side contact faces 34D of the gear plate 34 are then disposed at the lower side of the detent protrusions 36C of the clutch plate 36 as a result, the gear plate 34 is permitted to rotate with respect to the clutch plate 36 in the one of the rearward folding direction or the forward folding direction. The swing body 18, the visor 44, and the mirror 46 illustrated in FIG. 1 are thereby permitted to swing in the one of the rearward folding direction or the forward folding direction.

Then, when external force in the rearward folding direction or the forward folding direction acts on at least one of the visor 44 or the mirror 46, or if the motor 26 illustrated in FIG. 2 is driven so as to rotate the worm gear 32B, rotation force in the rearward folding direction or the forward folding direction is input to the gear plate 34 from the worm gear 32B. When the gear plate 34 rotates in the rearward folding direction or the forward folding direction with respect to the clutch plate 36 as a result, the urging force of the coil spring 38 causes the detent protrusions 36C of the clutch plate 36 to engage with the detent recesses 34E of the gear plate 34 as they move toward the lower side. The gear plate 34 is restricted from rotating in the rearward folding direction and the forward folding direction with respect to the clutch plate 36 as a result, thereby also restricting the swing body 18, the visor 44, and the mirror 46 illustrated in FIG. 1 from rotating in the rearward folding direction and the forward folding direction.

In the present exemplary embodiment as illustrated in FIG. 3, the grease 70 is present between the support face 20C of the case 20 and the supported face 34B of the gear plate 34 that are capable of rotating relative to each other. Moreover, the first groove 62 formed in the support face 20C as illustrated in FIG. 4 is formed in a ring shape running in the circumferential direction around the rotation center of the support face 20C (the swing axial center (CL) of the case 20). Thus, when the support face 20C and the supported face 34B (see FIG. 3) rotate relative to each other, wear of the support face 20C and the supported face 34B (see FIG. 3) is suppressed by the grease 70 flowing out from inside the first groove 62.

In the present exemplary embodiment, the second grooves 64 that link the radial direction inside end 60A of the support face 20C and the first groove 62 together, and the third grooves 66 that link the radial direction outside end 60B of the support face 20C and the first groove 62 together, are formed in the support face 20C. Note that the second grooves 64 and the third grooves 66 extend at an angle toward the same side as each other with respect to the radial direction of the support face 20C (the radial direction centered on the swing axial center (CL) of the case 20).

Thus, for example, in cases in which the support face 20C rotates in the rearward folding direction (the arrow A direction) relative to the supported face 34B (see FIG. 3), some of the grease that has spilled out onto the radial direction inside end 60A side of the support face 20C flows through the second grooves 64 to be supplied to the first groove 62 (see the arrow a1), and powdered abrasion debris is discharged through the third grooves 66 to the radial direction outside end 60B side of the support face 20C (see the arrow a2). Note that this powdered abrasion debris is powder generated by abrasion of the support face 20C and so on.

In contrast thereto, in cases in which the support face 20C rotates in the forward folding direction (the arrow B direction) relative to the supported face 34B (see FIG. 3), for example, some of the grease that has spilled out onto the radial direction outside end 60B side of the support face 20C flows through the third grooves 66 to be supplied to the first groove 62 (see the arrow b1), and powdered abrasion debris is discharged through the second grooves 64 to the radial direction inside end 60A side of the support face 20C (see the arrow b2).

This enables depletion of the grease between the support face 20C and the supported face 34B (see FIG. 3) to be slowed, and enables abrasion of the support face 20C and the supported face 34B (see FIG. 3) caused by powdered abrasion debris to be suppressed.

In the present exemplary embodiment, the connecting portions 64A of the second grooves 64 to the first groove 62 and the connecting portions 66A of the third grooves 66 to the first groove 62 are set at staggered positions in the extension direction of the first groove 62 (the circumferential direction of the first groove 62). Thus, when the support face 20C and the supported face 34B (see FIG. 3) rotate relative to each other and the grease flows into one of either the second grooves 64 or the third grooves 66, this grease can be suppressed from passing straight across the first groove 62 and being discharged from the other of either the second grooves 64 or the third grooves 66. This enables the grease 70 supplied into the first groove 62 to be efficiently utilized to suppress abrasion of the support face 20C and the supported face 34B (see FIG. 3).

In the present exemplary embodiment, as illustrated in FIG. 5A and FIG. 5B, the depth of the first groove 62 is set deeper than the respective depths of the second grooves 64 and the third grooves 66. This allows grease to accumulate in the first groove 62 at a position deeper than the second grooves 64 and the third grooves 66. This enables the grease 70 inside the first groove 62 to be suppressed from being discharged through the second grooves 64 and the third grooves 66. Since powdered abrasion debris generally floats on top of the grease, the powdered abrasion debris is discharged through the second grooves 64 or the third grooves 66, despite the second grooves 64 and the third grooves 66 being shallower than the first groove 62.

As explained above, the vehicle door mirror device 10 according to the present exemplary embodiment enables abrasion of the support face 20C of the case 20 and the supported face 34B of the gear plate 34 illustrated in FIG. 3, these being rotation-sliding portions, to be suppressed. Namely, anti-abrasion characteristics of the support face 20C of the case 20 and the supported face 34B of the gear plate 34 can be improved.

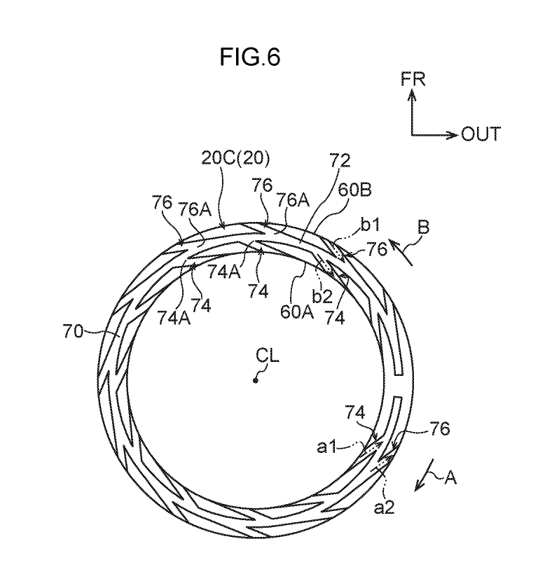

Explanation follows regarding a modified example of the above exemplary embodiment, with reference to FIG. 6. FIG. 6 is a plan view (a plan view corresponding to FIG. 4 of the above exemplary embodiment) illustrating a support face of a case of the modified example of the above exemplary embodiment, in a state viewed from the upper side. As illustrated in FIG. 6, the modified example differs from the above exemplary embodiment in the respect that a circular arc shaped first groove 72 is formed instead of the ring-shaped (circular) first groove 62 (see FIG. 4). Other configuration is basically the same as the configuration of the above exemplary embodiment. Configuration portions that are basically the same as those in the above exemplary embodiment are therefore appended with the same reference numerals, and explanation thereof is omitted as appropriate.

As illustrated in FIG. 6, in the modified example, the circular arc shaped first groove 72 is formed in the support face 20C so as to run in the circumferential direction around the rotation center of the support face 20C (the swing axial center (CL) of the case 20). The first groove 72 has similar configuration to the first groove 62 of the above exemplary embodiment (see FIG. 4), with the exception that the first groove 72 is formed in a substantially C shape resembling an interrupted circle. Plural second grooves 74 that link the radial direction inside end 60A of the support face 20C and the circular arc shaped first groove 72 together, and plural third grooves 76 that link the radial direction outside end 60B of the support face 20C and the circular arc shaped first groove 72 together, are also formed in the support face 20C.

Despite being connected to the circular arc shaped first groove 72 rather than the ring-shaped first groove 62 (see FIG. 4), the second grooves 74 are basically the same configuration portions as the second grooves 64 of the first exemplary embodiment (see FIG. 4). Moreover, despite being connected to the circular arc shaped first groove 72 rather than to the ring-shaped first groove 62 (see FIG. 4), the third grooves 76 also are basically the same configuration portions as the third grooves 66 of the first exemplary embodiment (see FIG. 4). Namely, the second grooves 74 and the third grooves 76 extend at an angle toward the same side as each other with respect to the radial direction of the support face 20C (the radial direction centered on the swing axial center (CL) of the case 20). Connecting portions 74A of the second grooves 74 to the first groove 72, and connecting portions 76A of the third grooves 76 to the first groove 72, are set at staggered positions in the extension direction of the circular arc shaped first groove 72. As an example, the respective depths of the second grooves 74 and the third grooves are set shallower than the depth of the first groove 72. In such a modified example, the advantageous effect of suppressing abrasion can be obtained by similar operation to that in the above exemplary embodiment.

Note that although the circular arc shaped first groove 72 is formed in a substantially C shape in the modified example illustrated in FIG. 6, a circular arc shaped first groove may be formed in a semicircular shape, or may be formed in circular arc shape shorter than a semicircle. Alternatively, for example, plural circular arc shaped first grooves with the same radius of curvature as each other may be formed.

As another modified example of the above exemplary embodiment, the angled directions of second grooves and third grooves with respect to the radial direction of a support face (20C) of a case (20) may both be set so as to be angled toward the opposite side to the side illustrated in FIG. 4.

Although the second grooves 64 and the third grooves 66 are formed running in straight lines in plan view as illustrated in FIG. 4 in the above exemplary embodiment, second grooves and third grooves may, for example, be formed in shapes that curve gradually away from a first groove.

Although the advantageous effect of suppressing abrasion would be exhibited less strongly than in the above exemplary embodiment, another modified example of the above exemplary embodiment may be adopted in which connecting portions (64A) of second grooves (64) to a first groove (62) and connecting portions (66A) of third grooves (66) to the first groove (62) are set in mutually aligned positions in the extension direction of the first groove (62).

As another modified example of the above exemplary embodiment, a configuration may be adopted in which the bottom position of the first groove 62 illustrated in FIG. 5A and FIG. 5B is set at the position illustrated by the double-dotted dashed line D (namely, a position at the same depth as the bottom positions of the second grooves 64 and the third grooves 66).

In addition to the configuration of the above exemplary embodiment, the supported face 34B of the gear plate 34 illustrated in FIG. 3 may also be formed with a ring-shaped first groove formed running in a circumferential direction around the rotation center of the supported face 34B, second grooves that are formed linking together a radial direction inside end of the supported face 34B and the first groove and that extend at an angle with respect to the radial direction of the supported face 34B, and third grooves that are formed linking together a radial direction outside end of the supported face 34B and the first groove and that extend at an angle toward the same side as the second grooves with respect to the radial direction of the supported face 34B.

In the above exemplary embodiment, an example has been given of a case in which the rotation-sliding portion structure of the present invention is applied to the rotation-sliding portions between the support face 20C of the case 20 and the supported face 34B of the gear plate 34. However, the rotation-sliding portion structure of the present invention may be applied to other rotation-sliding portions, such as the rotation-sliding portions between the support face portion 16D of the stand 16 and the supported face portion 20E of the case 20 illustrated in FIG. 3, or rotation-sliding portions between a substantially circular cylinder shaped wheel drive that is used to adjust a mirror face and is capable of rotating, and a support portion of the wheel drive in a vehicle door mirror device (such as the wheel drive and support portion therefor disclosed in Japanese Patent Application Laid-Open (JP-A) No. 2013-163498).

As another modified example of the above exemplary embodiment, the rotation-sliding portion structure of the present invention may be applied to a rotation-sliding portion in a vehicle camera device (vehicle visual recognition device) provided with a camera (visual recognition section that assists visual recognition of a vehicle occupant by capturing images) instead of the mirror 46 illustrated in FIG. 1. As a further modified example, the rotation-sliding portion structure of the present invention may be applied to a rotation-sliding portion of a vehicle outer mirror device (such as a vehicle fender mirror device) disposed at another location at the exterior of a vehicle, or of a vehicle mirror device (vehicle visual recognition device) such as a vehicle inner mirror device disposed in the interior of a vehicle.

Note that the above exemplary embodiments and the plural modified examples described above may be implemented in appropriate combinations.

Examples of the present invention have been given above; however, the present invention is not limited to the above examples, and obviously various other modifications may be implemented within a range not departing from the spirit of the present invention.

The entire disclosure of Japanese Patent Application No. 2016-82266 filed Apr. 15, 2016 is incorporated by reference in this specification.

1. A rotation-sliding portion structure comprising:
a pair of ring-shaped sliding faces that are capable of rotating relative to each other, a lubricant being present between the pair of ring-shaped sliding faces;
a ring-shaped or circular arc shaped first groove that is formed in at least one sliding face of the pair of ring-shaped sliding faces so as to run in a circumferential direction around a rotation center of the at-least-one sliding face;
a second groove that is formed in the at-least-one sliding face so as to link a radial direction inside end of the at-least-one sliding face and the first groove together, and that extends at an angle with respect to a radial direction of the at-least-one sliding face; and
a third groove that is formed in the at-least-one sliding face so as to link a radial direction outside end of the at-least-one sliding face and the first groove together, and that extends at an angle toward the same side as the second groove with respect to the radial direction of the at-least-one sliding face.

2. The rotation-sliding portion structure of claim 1, wherein a connecting portion of the second groove to the first groove and a connecting portion of the third groove to the first groove are set at positions staggered with respect to each other in an extension direction of the first groove.

3. The rotation-sliding portion structure of claim 1, wherein a depth of the first groove is set deeper than respective depths of the second groove and the third groove.

4. The rotation-sliding portion structure of claim 1, wherein the first groove is circular arc shaped and is formed in a substantially C shape.

5. The rotation-sliding portion structure of claim 1, wherein the first groove is circular arc shaped and is formed in a semicircular shape.

6. The rotation-sliding portion structure of claim 1, wherein the first groove is circular arc shaped and is formed in a circular arc shape shorter than a semicircle.
